(19) United States
(12) Patent Application Publication
(10) Pub. No.: US 2009/0268455 A1
(43) Pub. Date: Oct. 29, 2009

(54) LED LIGHTING DEVICE

(75) Inventor: Fabio ALLEGRI, Castel Goffredo (IT)

Correspondence Address: Pearne & Gordon LLP, 1801 East 9th Street, Suite 1200, Cleveland, OH, 44114-3108, US

(73) Assignee: COEMAR S.P.A., 46042 Castel Goffredo (Mantova) (IT)

(21) Appl. No.: 12/425,718

(22) Filed: Apr. 17, 2009

(30) Foreign Application Priority Data
Apr. 23, 2008 (IT) PR2008A000029

(51) Int. Cl. F21V 1/00

(52) U.S. Cl. 362/235

(57) ABSTRACT

LED lighting device comprising:
at least two light sources;
a single optical element positioned in proximity to the light sources and so shaped as to receive the light radiation emitted by said light sources and to project a single light beam;
wherein the device is modular, that is not monolithic, each of the light sources being separable from the device.

The present invention relates to a LED lighting device. In particular, the device is used in the entertainment industry to create versatile artificial lights, e.g. in shows or concerts.

As is well known, several types of lighting devices employing LED light sources are already available on the market. In particular, a first type of device is constituted by a group of monochromatic LEDs with emission distributed over the visible light spectrum. Said LEDs are mounted on a support and to each of them is coupled an optic element (generally, a lens). The lens, exploiting the refraction properties of the material whereof it is made, projects the light radiation received from the corresponding LED. Based on the shape of the lens, the radiation is concentrated or diffused.

Another known solution consists of grouping monochromatic emitters related to three fundamental colours (red, green and blue) in a single monolithic body or support in such a way as to obtain, through their combination, a broad range of colours. The three LEDs thus grouped, once housed in their support, can no longer be removed therefrom. In this case, a single lens is coupled to the group of LEDs in such a way that the light radiation projected by the lens, though it originates from three distinct LEDs, gives rise to a single beam of light.

A disadvantage of the first type of known devices resides in their bulk. Indeed, to produce a given hue, it is necessary to mount on the support the monochromatic LED corresponding to said hue. Moreover, a lens is necessary for each LED, with the consequent use of space and components.

The second type of devices, instead, while capable of obtaining hues through the mixing of the fundamental colours, has a disadvantage due to the impossibility of separating individual LEDs of the group from their support.

An additional drawback of the second type of devices is given by the need to stock a large number of devices, each with its own pre-determined combinations of LEDs of various colours.

Both known types of devices therefore have poor versatility.

Another disadvantage of the prior art (both for the first and for the second type of devices) is linked to the impossibility of lightening or darkening the colours by adding a white light component or of modifying the colour temperature of the LEDs. Colour temperature is a parameter usually employed to quantify light tone.

For example, consider the production of white light. In the first type of devices, it is necessary to add a white monochromatic LED and the related lens, which will project white light from a different point of light from that of the other LEDs present on the support. This white light cannot be mixed: it depends on the type of LED itself, whose colour temperature characteristic is set at the time of its manufacture and cannot be modified. In the second type of devices, instead, no additional LEDs can be mounted because the support is so shaped as to house only three emitters, which are inseparable. Therefore, white light can only be obtained by “simulation”, through an appropriate sum of the three fundamental colour components, i.e. red, green and blue (RGB). The absence of a “pure” white light prevents, in this case, to vary the colour temperature of the white colour itself. The considerations made about white light can be extended to any other colour whose chromatic characteristics one wishes to vary.

An object of the present invention is to eliminate the aforesaid drawbacks and to make available a versatile and compact LED lighting device.

Another object of the present invention is to make available a LED lighting device in which it is possible to project any hue and the white light at the desired colour temperature.

An additional object of the present invention is to avoid the need to stock a great number of different devices.

Said objects are fully achieved by the LED lighting device of the present invention, which comprises the characteristics contained in Claim 1 and in the subsequent claims.

These and other objects shall become more readily apparent from the following description of a preferred embodiment, illustrated purely by way of non limiting example in the accompanying drawing tables in which:

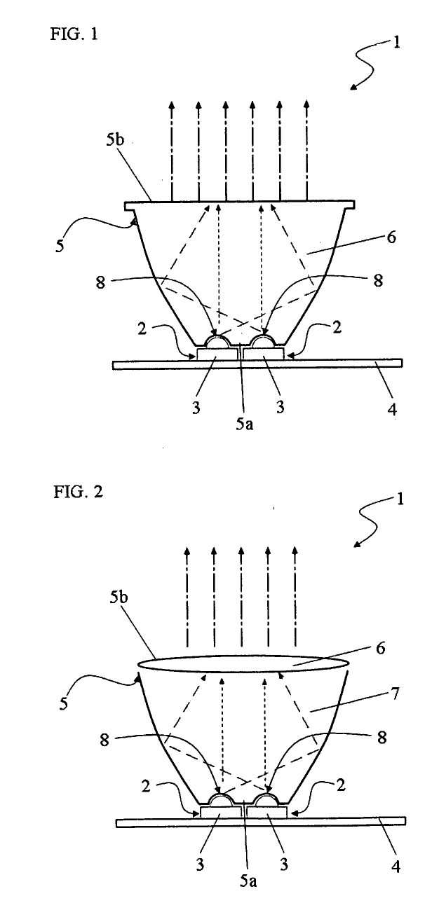

FIG. 1 shows a sectioned lateral view of a LED lighting device, in accordance with the present invention, in an operative position;

FIG. 2 shows a sectioned lateral view of a second embodiment of the device 1 of FIG. 1 in an operative position;

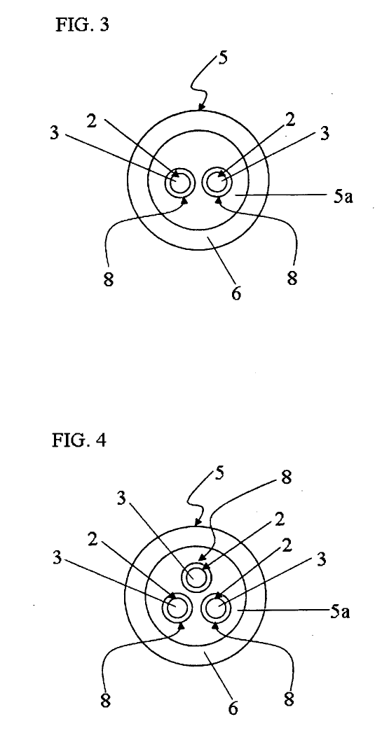

FIG. 3 shows a bottom view of the device of FIG. 1;

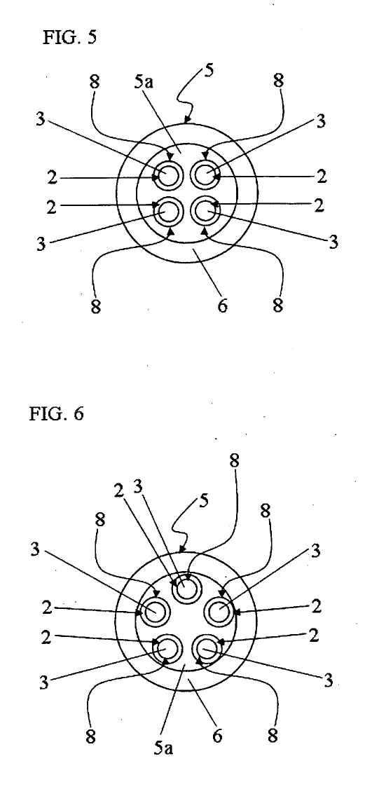

FIGS. 4, 5, 6 show bottom views of as many embodiments of the device of FIG. 1.

With reference to the figures, the number 1 indicates a LED lighting device, in particular for use in the entertainment industry to create versatile artificial lights.

The device 1 comprises at least two light sources 2, each of which is preferably constituted by a single LED 3. Advantageously, the device 1 is modular, i.e. not monolithic. Indeed, each of the light sources 2 is separable from the device 1. In the embodiments illustrated herein, the LEDs 3 are mounted on a support 4.

In proximity to the light sources 2 is positioned a single optical element 5 so shaped as to receive the light radiation emitted by the light sources 2 themselves. Based on the constructive characteristics of the optical element 5, the light radiation is projected forming a single beam of light. Preferably, the optical element 5 comprises a single lens 6 able to project the received light radiation, as shown in FIG. 1. The lens 6 is usually made of a polymer or clear glass and it can have different shape according to the effect to be obtained. The lens 6 is constructed according to known techniques, i.e. subdivided into a first portion able to gather the light, a second portion able to mix it and a final portion able to concentrate the light. The geometric properties of the lens 6 are defined according to the number of light sources 2 used. By exploiting the refraction properties of the material of the lens 6, the light can be diffused or concentrated. In a second embodiment, there is also a reflector 7 positioned between the light sources 2 and the lens 6, as shown in FIG. 2. The reflector 7 concentrates the light radiation emitted by the light sources 2 towards the lens 6.

Preferably, the light sources 2 are mutually close and equidistant. In this configuration, the light sources 2 interact in the same way with the optical element 5 and they are perceived as a single light emitter.

Preferably, the optical element 5 is positioned to cover the light sources 2. In particular, the optical element 5 presents a cavity 8 for housing the light sources 2. Preferably, in the optical element 5 is obtained a plurality of cavities 8, each of which is able to house one of the light sources 2.

Advantageously, said cavities 8 are complementarily shaped relative to the light sources 2 in such a way as to concentrate the light radiation emitted by the light sources 2 into the optical element.

Preferably, the light sources 2 and the optical element 5 are placed in contact. In particular, the light sources are inserted in the cavities 8 obtained on a face 5a of the optical element 5 and they are in contact with the walls that define said cavities 8. In this way, the light radiation emitted by the light sources 2 is substantially directed towards the optical element 5, i.e. towards the lens 6 itself. The optical element 5, exploiting the refraction properties of the material whereof it is made, concentrates or diffuses the light flow on a face 5b of the optical element 5 opposite to the face 5a housing the cavities.

Advantageously, it is possible to modify the colour temperature of any one of the light sources 2. Preferably, at least one of the light sources 2 is constituted by a white monochromatic LED 3. In this way, it is possible to have available a “pure” white light and it is further possible to vary its colour temperature mixing it with a percentage of colour not exceeding 30%.

The operation of the LED lighting device, according to the present invention, is substantially as follows.

The light sources 2, i.e. the LEDs 3, are mounted on the support 4 to create the desired colour combinations. To cover the LEDs 3 is placed the optical element 5, making each of the cavities 8 obtained in the optical element 5 match each LED 3.

From the above description, the characteristics of the LED lighting device according to the present invention are clear, as are its advantages. In particular, the light sources are globally associated with a single optical element, so the device is versatile and compact.

Moreover, it is possible to mount on the support monochromatic LEDs of any colour, whose light radiation can be mixed. Therefore, it is possible to project any hue at the desired colour temperature.

Lastly, it is possible to have available a pure (i.e. not simulated) white light, also varying its colour temperature.

1. LED lighting device comprising:
at least two light sources;
a single optical element positioned in proximity to the light sources and so shaped as to receive the light radiation emitted by said light sources and to project a single light beam,
wherein the device is modular, that is not monolithic, each of the light sources being separable from the device.

2. Device as claimed in claim 1, wherein it is possible to modify the colour temperature of any one of the light sources.

3. Device as claimed in claim 1, wherein the optical element presents a cavity to house the light sources.

4. Device as claimed in claim 1, wherein the optical element presents a plurality of cavities, each of which is able to house one of the light sources.

5. Device as claimed in claim 4, wherein the cavities are complementarily shaped relative to the light sources to concentrate into the optical element the light radiation emitted by the light sources.

6. Device as claimed in claim 1, wherein the light sources and the optical element are placed in contact in such a way that the light radiation emitted by the light sources is substantially directed towards the optical element.

7. Device as claimed in claim 1, wherein the optical element includes a single lens to project the light radiation received.

8. Device as claimed in claim 7, wherein the optical element further includes a reflector positioned between the light sources and the lens in such a way as to concentrate towards the lens the light radiation emitted by the light sources.

9. Device as claimed in claim 1, wherein the light sources are equidistant from each other in such a way that each of said light sources has identical interaction with the optical element.

10. Device as claimed in claim 1, wherein each of the light sources is constituted by a single LED.

11. Device as claimed in claim 1, wherein at least one of the light sources is constituted by a white monochromatic LED.

12. Device as claimed in claim 1, wherein the optical element is positioned to cover the light sources.
